(19) United States
(12) Patent Application Publication
(10) Pub. No.: US 2007/0199796 A1
(43) Pub. Date: Aug. 30, 2007

(54) INSTALLATION FOR SELF-SERVICE CASH REDEMPTION MACHINE AND METHOD

(76) Inventors: Robert E. Gunst, Neosho, WI (US); Michael Bielamowicz, Naperville, IL (US)

Correspondence Address: QUARLES & BRADY LLP, 411 E. WISCONSIN AVENUE, SUITE 2040, MILWAUKEE, WI, 53202-4497, US

(21) Appl. No.: 11/615,522

(22) Filed: Dec. 22, 2006

Related U.S. Application Data
(60) Provisional application No. 60/753,177, filed on Dec. 22, 2005.

(51) Int. Cl. G07F 9/10

(52) U.S. Cl. 194/350

(57) ABSTRACT

A cash redemption machine for receipt in a recess or aperture in a wall or other structure includes a sliding or rotational element mounted beneath the cabinet. In typical use, a front panel of the machine extends out of the recess, where it is accessible to customers to insert coins into a coin intake. The remainder of the machine extends into the recess, and the opening between the machine and the wall or structure is enclosed by side panels. When access to stored coins, service, or maintenance is required, the machine is rotated or slid about the sliding or rotational element, to allow access to the back portion of the machine.

### CROSS-REFERENCE TO RELATED APPLICATION

This application claims the benefit of U.S. provisional application Ser. No. 60/753,177, filed on Dec. 22, 2005.

### STATEMENT CONCERNING FEDERALLY SPONSORED RESEARCH OR DEVELOPMENT

Not applicable.

### FIELD OF THE INVENTION

The present invention relates to self-service cash redemption machines for receiving and processing a substantial batch of unsorted coinage and providing the user with a voucher or a form of credit, on a card, for example.

### BACKGROUND OF THE INVENTION

Since the introduction of state and local sales taxes, goods have been priced in such a way that people tend to accumulate a great deal of coinage. As people typically do not prefer to carry significant amounts of change in their pockets or purses, this coinage tends to accumulate in their homes.

Traditionally, there have been very few receivers of large amounts of coin change from consumers, other than banks, making it difficult for consumers to convert this excess coinage into other forms of currency. To deal with the increase in excess coinage, however, in recent years, certain voucher dispensing machines have been developed and placed, for example, in grocery stores. These machines collect coins from the consumer and provide a voucher to the consumer for redemption for cash or for buying, for example, groceries or other items at the store. Typically, some amount of the transaction is retained as a commission, usually less than 10%. Examples of machines for carrying out these transactions are shown and described in U.S. Pat. Nos. 6,736,251, 6,494,776, 6,484,863 and earlier related patents cited therein.

Various other types of machines for both receiving coins and providing the consumer with a credit are also known, including ATM machines and large cash handling machines for gaming operations. ATM machines have generally been limited to dispensing small amounts of change for a dollar, cash withdrawals in the form of bills, or pre-rolled rolls of coin. The large cash handling machines for gaming establishments sort the change into bins, which must then be emptied and further processed before being placed in dispenser and given to customers through cashiers.

ATM's have been installed in walls of a bank or other financial business, such that the machine is accessible outside of the bank or other financial business both during banking hours and after hours. These machines are accessible for servicing from the back side, from inside the bank or other financial business. Such a machine is disclosed, for example, in U.S. Pat. Pub. No. US2004/0099729. Other types of ATM enclosures are disclosed in U.S. Pat. Nos. 4,558,650 and 4,577,562.

With self-service cash redemption machines, there may be installations in which the machine will not be accessible from the back side of a wall, in the case of a supermarket, for example. There remains a need, therefore, for a new type of installation for a self-service coin cash redemption machine, which is easy, and convenient to service and maintain, and which allows easy access for personnel to remove accumulated coinage. The machine should also be capable of dispensing a voucher, a credit to the depositor or notes and a small amount of change to the consumer.

### SUMMARY OF THE INVENTION

The invention relates generally to an apparatus and system for sorting and counting substantial number of unsorted coins, typically far greater than the amount of coins inserted into vending machines for purchasing items. The coins are deposited into a machine, which sorts the coins into a plurality of denominations, tallies a total value, and dispenses a voucher or a form of credit to the user for either the total amount or an amount less than the total. The machine therefore offers a service to the consumer, and can also provides a commission to a sponsoring organization.

In one aspect, the invention relates to a cash redemption machine installed in a recess in a wall or barrier and closed on two lateral front sides by flaps, the machine being mounted on a rotation device to be rotatable in either rotational direction so as to permit a service technician to access the machine through service doors on left and right sides of the machine. In contrast to the prior art, the machine and accumulated coins are accessible from the front or customer side, while the service doors for security are shielded from access from the customer side. The machine may also be mounted to a translational device, to be moved back and forth through an access area.

In another aspect of the invention, a kit for installing a cash redemption machine into a recess in a wall or structure is provided. The cash redemption machine has a coin intake in a first surface and a coin access panel in a second surface, and the kit enables the machine to be moveably installed into a recess in a structure to allow access to alternate sides of the machine. The kit includes a machine positioning assembly adapted to be coupled to a bottom surface of the cash redemption machine for moving the machine between positions, and therefore to selectively provide access to at least one of the first and the second surface. The kit further includes at least one side panel. The side panel is adapted to be mounted between the structure and the cash redemption machine, and is moveable between a first position enclosing a space between the structure and the cash redemption machine and a second position providing an opening between the cash redemption machine and the structure. The panels can be moved to allow repositioning of the machine using the machine positioning assembly.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a front perspective view in elevation of a first embodiment of a self-service cash redemption machine installation according to the present invention;

FIG. 2 is the same view as FIG. 1, except that two side panels are in an open position;

FIG. 3 is the same view as FIG. 2, except that the machine has been rotated counterclockwise and a first access door on the machine has been opened;

FIG. 4 is the same view as FIG. 2, except that the machine has been rotated clockwise and a second access door on the machine has been opened; and

FIG. 5 is a bottom perspective view of the installation of FIG. 1 according to the present invention.

### DETAILED DESCRIPTION OF THE PREFERRED EMBODIMENT

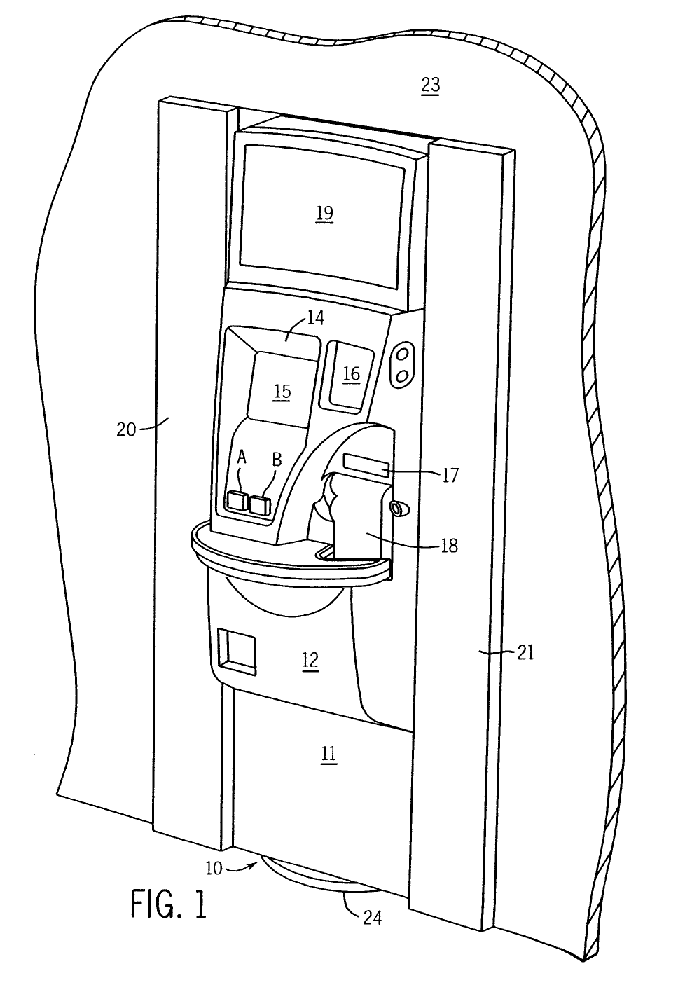

FIG. 1 shows a self service cash redemption machine 10 in an installation in accordance with the present invention. The machine 10 is housed in a cabinet enclosure 11 having a façade 12. The façade 12 has an opening 14 for viewing a visual display screen 15. Below this screen 15 are two buttons “A” and “B” for allowing the user to enter selections of items on the screen 15. To the right of the display is an area for an advertising display 16 and below that a printout slot 17 for receiving a receipt or other printable matter that exits a printer installed inside the enclosure 11. Just below the printer output slot 17 is a coin intake area 18 with a mechanism (not shown) for feeding coins into the machine 10. A powered feeding mechanism is described in a co-pending U.S. patent application Ser. No. 11/005,251, filed Dec. 6, 2004, and assigned to the assignee herein, which is hereby incorporated by reference for its description of such devices.

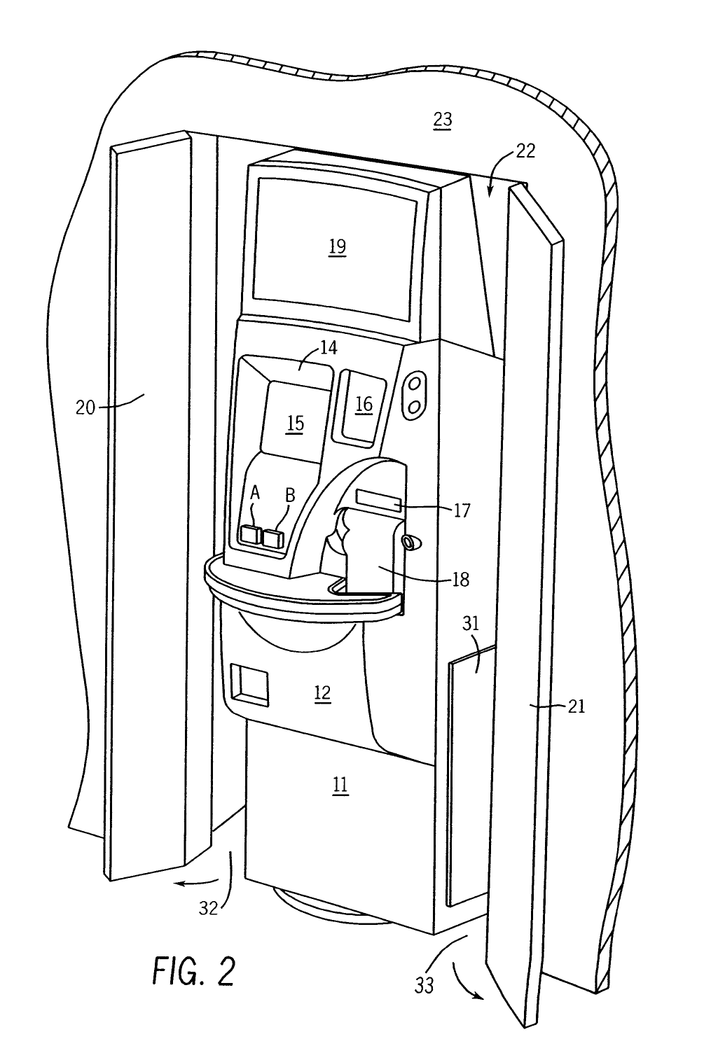

The façade 12 in FIG. 1 is framed by the floor on the bottom, by two side panels 20, 21 to the right and left and by a marquee 19 positioned above the façade 12 and between the two side panels 20, 21. As seen in FIGS. 2-4, the machine 10 is situated in a recess 22 or alcove in a wall 23, structure, or other barrier. The side panels 20, 21 enclose an area or space between the wall 23 and the machine 10, and can be pivoted open to provide access to rotate the machine 10. Locks can be provided on the panels 20, 21, and the panels 20, 21 can also be used to display advertising, information or graphics. Although, as shown, the side panels 20 and 21 are pivotally coupled to the adjacent wall or structure, in alternative embodiments, the side panels could also be coupled to the machine 10. Furthermore, the panels 20 and 21 could also be slidable pocket doors, or folding doors which can be selectively positioned to enclose the space between the wall or structure and the machine 10, or hooked, latched, or otherwise coupled between the machine 10 and adjacent wall or structure.

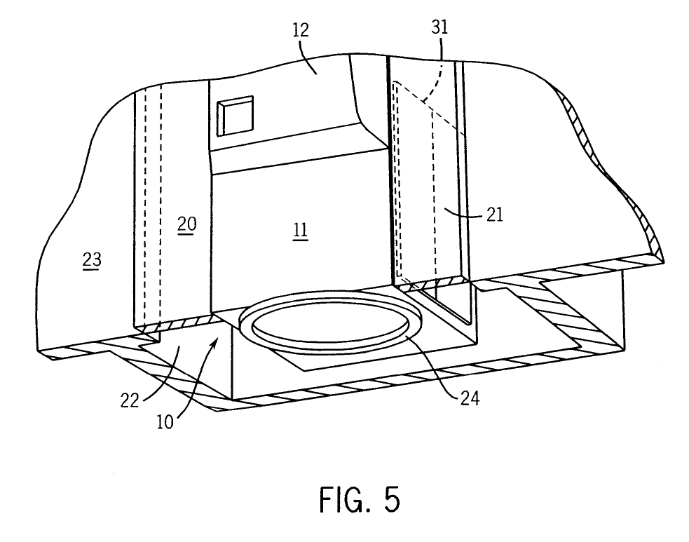

Referring now to FIG. 5, the machine 10 is mounted on a machine positioning assembly, such as a rotating ring assembly 24, so as to be rotatable when the side panels 20, 21 are in an open position as seen in FIGS. 2-4. A cover (not shown) is provided over that portion of the ring assembly 24 that projects forward in FIG. 5. The ring assembly 24 has a suitable weight carrying capacity for serving as a support for the machine 10. The machine 10 is preferably rotated between sixty degrees and seventy degrees (not to scale in the drawings) to access to the side doors, 30, 31, while still allowing observation of the displays 15, 16 and the printout slot 17 on the façade 12 of the machine 10. In alternative embodiments the range can be from forty-five to ninety degrees. To permit this rotation, the clearance spaces 32,33 between the sides of the machine 10 and the sides of the machine recess 22 or alcove is typically about ten inches.

To improve access to the machine 10 when in the recess 22, the machine positioning assembly may comprise a translational assembly to provide translational motion as opposed to or in addition to the rotational motion described above. Here, the repositioning assembly mounted to the machine can include one or more slideable rails or other elements that enable movement of the machine 10 forward and backward into and out of the recess 22. For example, a first rail can be mounted to the floor or other underlying surface and a second rail, sized and dimensioned to be slideably received in the first rail, mounted to a bottom surface of the machine 10, allowing the machine to be slid back and forth along the rail system. Various other methods for simplifying movement of the machine 10 into and out of the recess will be apparent to those of skill in the art. Moreover, sliding and rotating elements can be combined to allow the machine 10 to be pulled into and out of the recess and rotated to provide improved access.

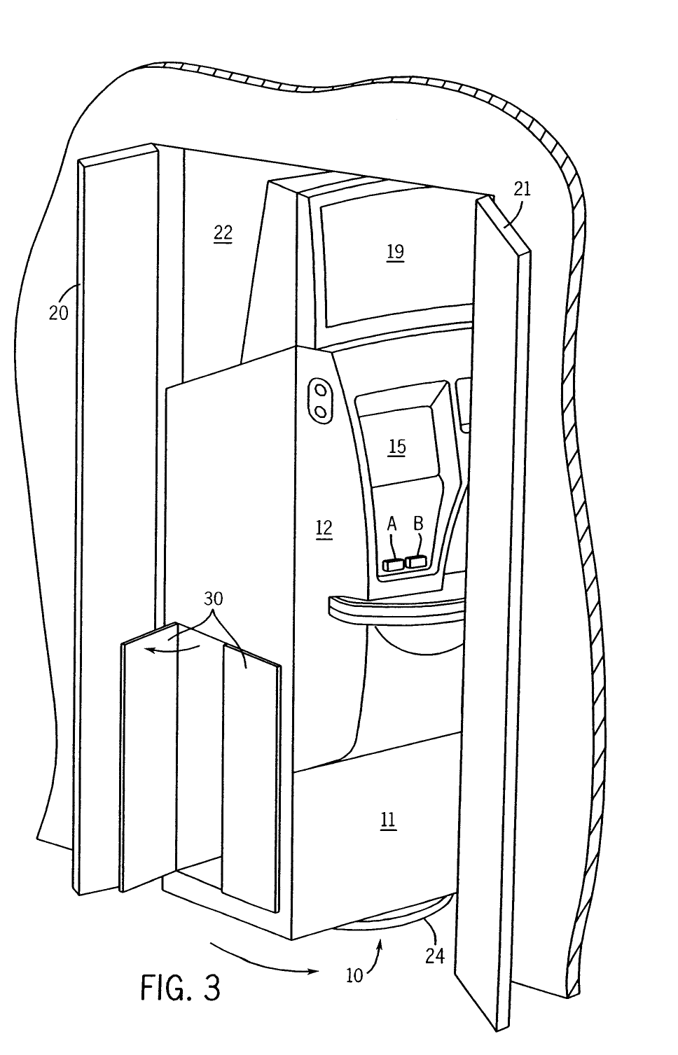

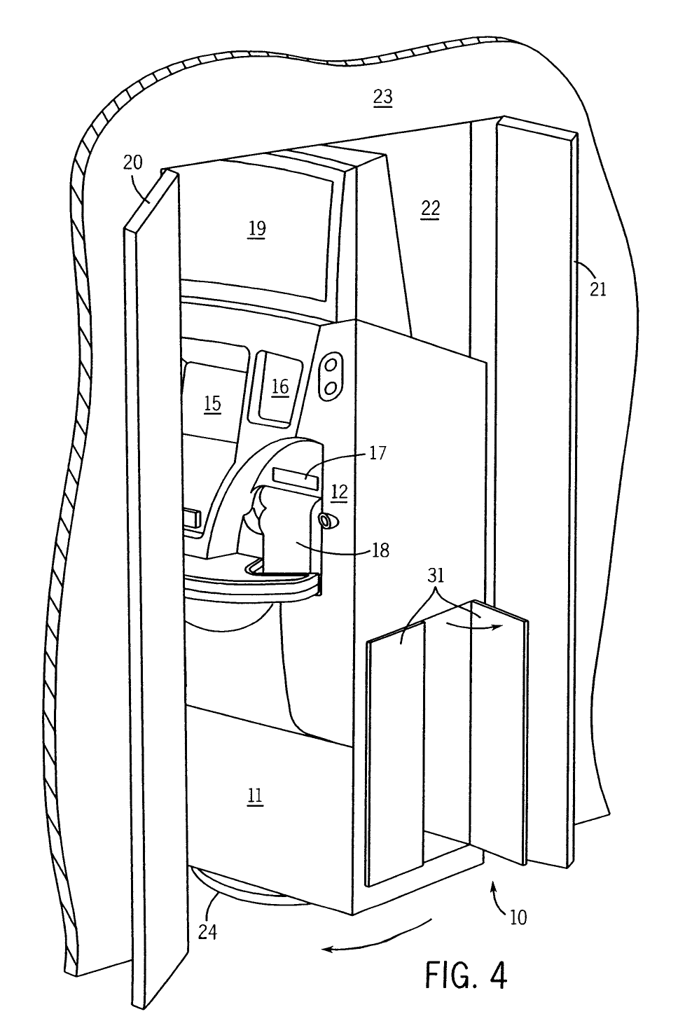

Referring now to FIG. 3, the machine 10 is shown rotated between sixty degrees and seventy degrees counterclockwise to present access doors 30 on the left side of the machine 10 for access to cash receptacles or to service other mechanisms in the machine 10. FIG. 4 shows the machine 10 rotated between sixty degrees and seventy degrees counterclockwise to present access doors 31 on the right side of the machine 10 for access to cash receptacles or to service other mechanisms in the machine 10. The doors are typically provided with locks (not shown), and can be either hinged panels or removable access panels.

When opened, the access doors 30, 31 allow access to remove full coin bags or other receptacles and allow their replacement with empty ones. The access doors, 30, 31 could also be opened to attend to mechanisms inside the machine 10.

In one embodiment of the invention, the machine positioning assembly and one or more side panels 20 and 21 can also be provided in a kit for installation with a cash redemption system. The machine positioning assembly can include a rotational ring assembly 24, a translational assembly, or both. In addition, coupling elements for coupling the side panels to the machine 10 or adjacent structure can also be provided.

It will be apparent to those of ordinary skill in the art that other modifications might be made to these embodiments without departing from the spirit and scope of the invention. A preferred embodiment of the invention has been described in considerable detail. Many modifications and variations to the preferred embodiment described will be apparent to a person of ordinary skill in the art. Therefore, the invention should not be limited to the embodiment described.

I/We claim:

1. A cash redemption system comprising:
a cabinet enclosure;
a coin intake for feeding coins into a cash receptacle in the enclosure;
an access door for providing access to the coin receptacle; and
a rotational ring assembly coupled to a bottom surface of the cabinet enclosure, the rotational ring assembly selectively rotating the cabinet enclosure to allow access to the access door and the coins in the cash receptacle.

2. The cash redemption system as defined in claim 1, wherein the coin intake is provided on a front side of the cabinet enclosure and the access door is provided on an adjacent side of the cabinet enclosure.

3. The cash redemption system as defined in claim 1, further comprising a second access door on a second adjacent side to the front side of the cabinet enclosure.

4. The cash redemption system as defined in claim 1, further comprising a printer for printing a receipt for coins receipted through the coin intake.

5. The cash redemption system as defined in claim 1, wherein each of the access doors further comprises a lock.

6. The cash redemption system as defined in claim 1, further comprising a display.

7. The cash redemption system as defined in claim 1, further comprising an advertising panel.

8. The cash redemption system as defined in claim 1, further comprising at least one side panel for selectively closing or opening a space between the cash redemption center and a structure.

9. The cash redemption system as defined in claim 1, further comprising a translational assembly coupled between the cabinet enclosure and an underlying surface for moving the cash redemption center translationally into and out of a recess.

10. A kit for enabling a cash redemption machine having a coin intake in a first surface and a coin access panel in a second surface to be moveably installed into a recess in a structure to allow access to alternate sides of the machine, the kit comprising:
a machine positioning assembly adapted to be coupled to a bottom surface of the cash redemption machine for moving the machine to selectively provide access to at least one of the first and the second surface; and
at least one side panel adapted to be mounted between the structure and the cash redemption machine, wherein the panel is moveable between a first position enclosing a space between the structure and the cash redemption machine and a second position providing an opening between the cash redemption machine and the structure.

11. The kit as defined in claim 10, wherein the machine positioning assembly comprises a rotational ring assembly.

12. The kit as defined in claim 10, wherein the machine positioning assembly comprises a translational assembly.

13. The kit as recited in claim 10, further comprising a second side panel adapted to be pivotally mounted between the structure and the cash redemption machine, the second panel being pivotable between a first position enclosing a space between the structure and the cash redemption machine and a second position providing an opening between the cash redemption machine and the structure.

14. A cash redemption system comprising:
a cabinet enclosure;
a coin intake for feeding coins into a cash receptacle in the enclosure;
an access door for providing access to the coin receptacle; and
a machine positioning assembly coupled to a bottom surface of the cabinet enclosure, the machine positioning assembly providing at least one of rotational or translational movement to the cabinet enclosure wherein the cabinet enclosure is moveable about the machine positioning assembly to allow access to the coins in the cash receptacle.

15. The cash redemption center as defined in claim 14, wherein the machine positioning assembly is a rotational ring assembly, and the cabinet enclosure is rotational about the ring assembly.

16. The cash redemption center as defined in claim 14, wherein the machine positioning assembly is a translational assembly, and the cabinet enclosure is moveable translationally about the assembly.
